(19) United States
(12) Patent Application Publication
(10) Pub. No.: US 2024/0422516 A1
(43) Pub. Date: Dec. 19, 2024

(54) CONFLICT MANAGEMENT OF AN OPEN-RADIO ACCESS NETWORK

(71) Applicant: Dell Products, L.P., Round Rock, TX (US)

(72) Inventors: Hoda Dehghan, Kanata (CA); Gwenael Poitau, Montreal (CA)

(21) Appl. No.: 18/336,299

(22) Filed: Jun. 16, 2023

(51) Int. Cl. H04W 4/50; H04W 28/16; H04W 72/56

(52) U.S. Cl. CPC H04W 4/50; H04W 28/16; H04W 72/56

(57) ABSTRACT

The described technology is generally directed towards conflict management of applications implemented on a radio access network (RAN) network. Various embodiments are presented to enable identification of a potential conflict (e.g., where an application is being onboarded) as well as a present conflict (e.g., where two or more applications are already operational). Conflicts may directly affect a control target, e.g., two applications are trying to control the same target. Conflicts may indirectly affect a control target, two applications affect a first metric and a second metric, but a third metric is affected. Conflict resolution includes preventing an application onboarding, terminating operation of an application, identifying causes unrelated to the application, and suchlike. Conflict resolution can be conducted at a RAN intelligent controller (RIC).

### BACKGROUND

Radio access networks (RANs) provide wide-area wireless connectivity to mobile devices. A RAN can be constructed from devices manufactured by disparate vendors. Given the potentially vast scale and complexity of RANs developed to meet the ever-increasing demand for cellular communications, various vendor consortiums have been formed with a view to generating specifications to facilitate configurations, techniques, methods, equipment, etc., for respective communications on a RAN. Such consortiums include the Third Generation Partnership Project (3GPP), Long-Term Evolution Fourth Generation (LTE 4G), Fifth Generation/New Radio (5G, 5G/NR), and most recently, the Open-Radio Access Network (O-RAN).

An impetus of O-RAN is for an open, disaggregated RAN, which can be achieved by splitting the RAN architecture, applications (e.g., xApps), and protocols into different, independent components. Disaggregation is anticipated to reduce energy consumption, improve system performance, and allow for rapid, open innovation in different components while ensuring a multi-vendor, vendor agnostic, operability network.

The above-described background is merely intended to provide a contextual overview of some current issues and is not intended to be exhaustive. Other contextual information may become further apparent upon review of the following detailed description.

### SUMMARY

The following presents a simplified summary of the disclosed subject matter to provide a basic understanding of one or more of the various embodiments described herein. This summary is not an extensive overview of the various embodiments. It is intended neither to identify key or critical elements of the various embodiments nor to delineate the scope of the various embodiments. The sole purpose of the Summary is to present some concepts of the disclosure in a streamlined form as a prelude to the more detailed description that is presented later.

In one or more embodiments described herein, systems, devices, computer-implemented methods, configurations, apparatus, and/or computer program products are presented to identify and address operational conflict between applications implemented on a RAN.

According to one or more embodiments, a computer-implemented method is provided, wherein the method comprises receiving, by a device comprising a processor, a request to onboard a first application (xApp), wherein the first xApp is configured to adjust a first metric of a radio access network (RAN). The method can further comprise determining, by the device, whether adjustment of the first metric causes a conflict with current operation of the RAN. In an embodiment, the RAN is an open-RAN (O-RAN).

In an embodiment, the method can further comprise determining, by the device, whether the RAN is able to support adjustment of the first metric by the first xApp, and further, in response to the RAN being determined to be unable to support adjustment of the first metric by the first xApp, denying, by the device, an onboarding request from the first xApp to operate the first xApp at the RAN.

In a further embodiment, the method can further comprise determining, by the device, a second metric adjusted by a second xApp, wherein the first metric of the first xApp and the second metric of the second xApp have a common control target, and further, in response to determining, by the device, the first metric of the first xApp and the second metric of the second xApp have a common control target, further determining, by the device, whether the first metric of the first xApp deleteriously affects operation of the common control target as a function of operation of the common control target adjusted by the second metric of the second xApp. Further, in response to the first metric of the first xApp being determined to be deleteriously affecting the operation of the common control target as a function of the operation of the common control target adjusted by the second metric of the second xApp, denying, by the device, an onboarding request from the first xApp to operate the first xApp at the RAN.

In another embodiment, the method can further comprise (i) in response to the first metric of the first xApp being determined to be deleteriously affecting the operation of the common control target as a function of the operation of the common control target adjusted by the second metric of the second xApp, applying, by the device, a first priority to the first xApp and a second priority to the second xApp, wherein the first priority has a higher priority than the second priority, (ii) based on the higher priority, executing, by the device, the first xApp, (iii) terminating, by the device, operation of the first xApp, and (iv) executing, by the device, the second xApp. In an embodiment, the operation of the first xApp can be terminated based on a configured duration of time.

In another embodiment, the method can further comprise identifying, by the device, a second metric adjusted by a second xApp, wherein the first metric and the second metric are disparate, and further, determining, by the device, that a third metric operating at the device is being negatively affected by an interaction resulting from the first metric being adjusted by the first xApp and the second metric being adjusted by the second xApp. In a further embodiment, the method further comprises terminating, by the device, execution of the first xApp.

Further embodiments can utilize a system, comprising at least one processor, and a memory coupled to the at least one processor and having instructions stored thereon, wherein, when executed by the at least one processor, the instructions facilitate performance of operations, comprising identifying a first metric of a radio access network (RAN) being controlled by a first application (xApp), further identifying a second metric of the RAN being controlled by a second xApp, and determining whether control of the second metric is being adversely affected by control of the first metric by the first xApp. In an embodiment, the system is one of a real-time RAN intelligent controller (RIC), a near-real-time RIC, or a non-real-time RIC.

For some context, example, non-limiting Non-Real Time RIC (Non-RT RIC) functions include service and policy management, RAN analytics, and model training for the near-Real Time RICs. In this regard, the Non-RT-RIC enables non-real-time (e.g., a first range of time, such as >1 s) control of RAN elements and their resources through applications, e.g., specialized applications called rApps. Example, non-limiting Near-Real Time RIC (Near-RT RIC) functions enable near-real-time optimization and control and data monitoring of CU and DU nodes in near-RT timescales (e.g., a second range of time representing less time than the first time range, such as between 10 ms and 1 s). In this regard, the Near-RT RIC controls RAN elements and their resources with optimization actions that typically take about 10 milliseconds to about one second to complete, although different time ranges can be selected. The Near-RT RIC can receive policy guidance from the Non-RT-RIC and can provide policy feedback to the Non-RT-RIC through specialized applications called xApps. In this regard, a Real Time RIC (RT RIC) is designed to handle network functions at real time timescales (e.g., a third range of time representing less time than the first time range and the second time range, such as <10 ms).

In a further embodiment, the operations can further comprise, in response to determining that the control of the second metric by the second xApp is being adversely affected by control of the first metric by the first xApp, terminating operation of the first xApp.

In another embodiment, the operations can further comprise, in response to determining that the control of the second metric by the second xApp is being adversely affected by the control of the first metric by the first xApp, operating the first xApp for a first period of time, and operating the second xApp for a second period of time, wherein the first period of time and the second period of time are non-overlapping and disparate.

In another embodiment, the operations can further comprise, (i) in response to determining that the control of the second metric by the second xApp is not being adversely affected by the control of the first metric by the first xApp, determining operation of a third metric at the RAN, (ii) determining whether the operation of the third metric at the RAN is being adversely affected by a combination of the first metric being controlled by the first xApp and the second metric being controlled by the second xApp, and (iii) in response to determining that operation of the third metric at the RAN is being adversely affected by the combination of the first metric being controlled by the first xApp and the second metric being controlled by the second xApp, terminating operation of the first xApp.

In an embodiment, the first metric can have a key performance indicator (KPI) configured to identify operation of the first metric, and wherein the first metric relates to at least one of coverage of the RAN, capacity of the RAN, or an energy-related performance of the RAN.

Further embodiments can include a computer program product stored on a non-transitory computer-readable medium and comprising machine-executable instructions, wherein when executed, the machine-executable instructions cause a machine to perform operations, comprising identifying a first operational characteristic of a first application (xApp), further identifying a second operational characteristic of a second xApp, wherein the first xApp and second xApp are configured to be executed via a radio access network (RAN), and further determining whether the first operational characteristic of the first xApp is threshold likely to negatively affect the second operational characteristic of the second xApp in the event of the first xApp being co-deployed on the RAN with the second xApp. In an embodiment, the machine is one of a real-time RAN intelligent controller (RIC), a near-real-time RIC, or a non-real-time RIC.

In another embodiment, the operations can further comprise responsive to a determination that the first operational characteristic of the first xApp is threshold likely to negatively affect the second operational characteristic of the second xApp in the event of the first xApp being co-deployed on the RAN with the second xApp, and further denying onboarding of the first xApp on the RAN.

In another embodiment, the operations can further comprise, responsive to a determination that the first operational characteristic of the first xApp is a not threshold likely to negatively affect the second operational characteristic of the second xApp in the event of the first xApp being co-deployed on the RAN with the second xApp, co-deploying, on the RAN, the first xApp with the second xApp, resulting in a co-deployment of the first xApp and the second xApp. The operations can further comprise (i) monitoring operation of a metric at the RAN, (ii) determining whether the operation of the metric at the RAN is being adversely affected by the co-deployment of the first xApp and the second xApp, and further (iii) responsive to the metric being determined to be adversely affected by the co-deployment of the first xApp and the second xApp, terminating operation of the first xApp.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 presents a system comprising various components/devices and various types of interaction/analysis that can be performed regarding conflict management between various xApps deployed on a RAN, in accordance with an embodiment.

FIG. 2 illustrates a system comprising xApp conflict management architecture, in accordance with an embodiment.

FIG. 3 presents an xApp conflict management system, in accordance with an embodiment.

FIG. 4 presents a system comprising an PM Engine component, in accordance with an embodiment.

FIG. 5 presents a high level structure of a conflict detection subcomponent, in accordance with an embodiment.

FIG. 6 presents a structural framework for a conflicting xApps detection component configured to detect conflicting xApps, in accordance with an embodiment.

FIG. 7 illustrates a methodology for determining whether an operational conflict arises by operating/executing an xApp on a RAN, in accordance with one or more embodiments described herein.

FIG. 8 illustrates a methodology for determining whether an operational conflict arises by operating/executing an xApp on a RAN, in accordance with one or more embodiments described herein.

FIG. 9 illustrates a methodology for determining whether an operational conflict arises by operating/executing an xApp on a RAN, in accordance with one or more embodiments.

FIG. 10 illustrates a methodology for deploying an xApp on a RAN based on KPI class, in accordance with one or more embodiments described herein.

FIG. 11 illustrates an example wireless communication system, in accordance with one or more embodiments described herein.

FIG. 12 illustrates an example environment for implementing various embodiments.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is to be appreciated, however, that the various embodiments can be practiced without these specific details, e.g., without applying to any particular networked environment or standard. In other instances, well-known structures and devices are shown in block diagram form in order to facilitate describing the embodiments in additional detail.

The various embodiments presented herein relate to utilizing a conflict management system (CMS) in conjunction with conflict detection and mitigation strategies. The CMS can be configured to enable implementation in any of real time (RT), near-RT, and/or non-RT. The CMS is configured to comply with O-RAN platform requirements, xApp requirements, and respective RAN intelligent controller (RIC) application programming interface (API) requirements.

Per the respective embodiments, one or more systems are presented that are configured to support multi-xApp interaction. A combination of preventive measures and reactive measures engenders co-deployment of xApps with interaction possible. Based on detected conflicts and/or predicted conflicts, xApp subscriptions/deployments at the RAN can be adjusted to avoid conflicting control actions. xApp subscription management enables operators to adjust the deployment strategy of their xApps. Further, implementation of machine learning (ML) and/or artificial intelligence (AI) based models can provide interventional commands to E2-nodes when priority assessment and subscription adjustments may not be an effective solution.

For pre-action/deployment measures, during an onboarding procedure the respective xApps can provide a descriptor that includes any of: configuration information, control (level and type of control) information, targeted key performance indicator (KPI) category and sub-category, xApp classification, and suchlike. The provided descriptors can be used by the CMS to trigger preventive measures.

For the post-action/post-onboarding measures, a RIC can act as an xApp-independent observer to detect conflicting xApps based on performance monitoring.

Per the respective systems/technologies presented herein, with a multi-xApp interaction framework, respective ML technologies can be utilized to learn/identify the “projection” of performance change. The ML can further predict KPIs in advance to establish the baseline behavior. One or more ML technologies/models can be deployed to enable correlation to be established between xApp actions and the performance change, and further determine the xApps that lead to opposite performance directions.

During an onboarding process, a restrictive framework can be utilized in which RIC restricts the selection range instead of free selection of all information open to an xApp for which onboarding is being requested. Accordingly, the RIC can specify the list of targeted KPIs for xApp to choose from based on App classifications and can also specify a list of allowed actions for xApp to choose from based on the targeted KPIs. Furthermore, per the various embodiments presented herein, dimensioning can be utilized to limit the number of xApps allowed to target the same class/KPI category.

### TERMS

xApp: an application deployable at an O-RAN (e.g., at the RIC) and configured to optimize/automate RAN operations in conjunction with supporting use cases directed at lowering an operator's (e.g., a mobile operator) total cost of ownership (TCO), enhancing a customer's quality of experience (QoE), and suchlike.

Class/KPI Category: respective KPIs can be separated into classes, whereby each KPI can have its own class. Each xApp (e.g., each of xApps 120A-n) can be assigned/associated with the KPI that is the operational focus of the respective xApp. Accordingly, a potential conflict regarding a KPI can be rapidly identified based on classifying a first xApp (e.g., during onboarding) to a KPI, and determining the operational effect of the first xApp on the one or more xApps that have already been classified for that particular KPI. Further, to maintain operational efficiency of the RAN and to mitigate potentially unforeseeable conflicts, the number of xApps that can be supported/operate for a particular KPI class can be limited. The fewer the number of xApps affecting a particular KPI, the less likelihood of a conflict arising, whether foreseen or unforeseen.

Dimensioning: limiting number of xApps based on KPI classification of the respective xApp.

Key Performance Indicator (KPI): provides a quantifiable measure of performance for a particular objective. KPIs can pertain to accessibility, availability, integrity, mobility, retainability, and suchlike.

Key Performance Measure (KPM): provides a measure of performance for a KPI.

Nodes & E2 Nodes: RAN architecture can include a range of units referred to as nodes, such as central units (CUs), distributed units (DUs), and radio units (RUs). Generally, CUs centralize RAN packet processing functions, DUs conduct baseband processing functions across cell sites, and RUs provide radio functions at antenna sites. While the RUs are located at antenna sites, the locations of CUs and DUs are not fixed to any particular geographic area or site. DUs can be co-located with RUs local to an antenna, also DUs can be located many miles from RUs, whereby connection between the DUs and RUs is by any suitable technology, e.g., fiber optics. CUs and DUs can be located “in the cloud”, such as at a data center which may or may not be proximal to the RU.

O-cloud: an operational layer including hardware and software components providing cloud computing capabilities to execute various RAN network functions. O-cloud functions can include O-DU, O-CU-CP, O-CU-UP, O-eNB, near-RT RIC, and non-RT RIC.

Preventative Measures: conflict management performed before a potentially adverse xApp is deployed/operates, such that an xApp that could negatively affect operation of a RAN is prevented from being onboarded/deployed/operated.

RAN Intelligent Controller (RIC): The RIC is an O-RAN component configured to control and optimize RAN functions. The RIC enables O-RAN disaggregation with regard to onboarding of multi-vendor/third-party xApps to automate/optimize RAN operations, e.g., with regard to use cases that lower mobile operators' TCO, enhance customers' QoE, and suchlike. The RIC can control what xApps are deployed on a RAN.

Reactive Measures: conflict management performed while multiple xApps are deployed/operated, such that interactions between the multiple xApps and effect on respective KPIs are identified and resolved.

n is any positive integer.

### 1. OVERVIEW

While an impetus of O-RAN is for an open, disaggregated RAN, the openness of the RAN architecture and protocols can give rise to (i) an xApp may not be supported by the RAN, (ii) various conflicts when multiple applications (xApps) are co-deployed on a RAN, and/or (iii) an xApp may adversely affect/cause a degradation in the performance of another xApp and/or RAN performance. System providers/operators may not be aware of the potential conflicts that may arise from deploying certain xApps on the same RAN site simultaneously. Conflicting xApps may cause performance degradation in the RAN and/or the RIC. A conflict can occur when a first xApp attempts to overwrite a policy or an action recently applied/configured/set by a second xApp. This overwrite scenario may cause the first xApp and the second xApp to be stuck in a state of “ping pong”, wherein the first xApp is constantly overwriting second xApp's decisions/configurations (and vice versa), leading to degradation in performance in the RIC and/or the RAN.

The various embodiments presented herein are configured to observe xApp behaviors to identify/infer potential and existing conflicts between various xApps, and further manage/mitigate deleterious effects of deploying one or more conflicting xApps on a RAN and/or an RIC. When a negative relationship between xApps is identified, a warning/alert can be generated whenever a problematic combination of xApps is/may be deployed on a RAN site, to assist in avoiding direct and indirect conflicts. In an embodiment, by utilizing current or historic data regarding operation between two or more xApps, warnings/alerts can be raised to prevent a combination of xApps from being destroyed and deleteriously affecting operation of the RAN.

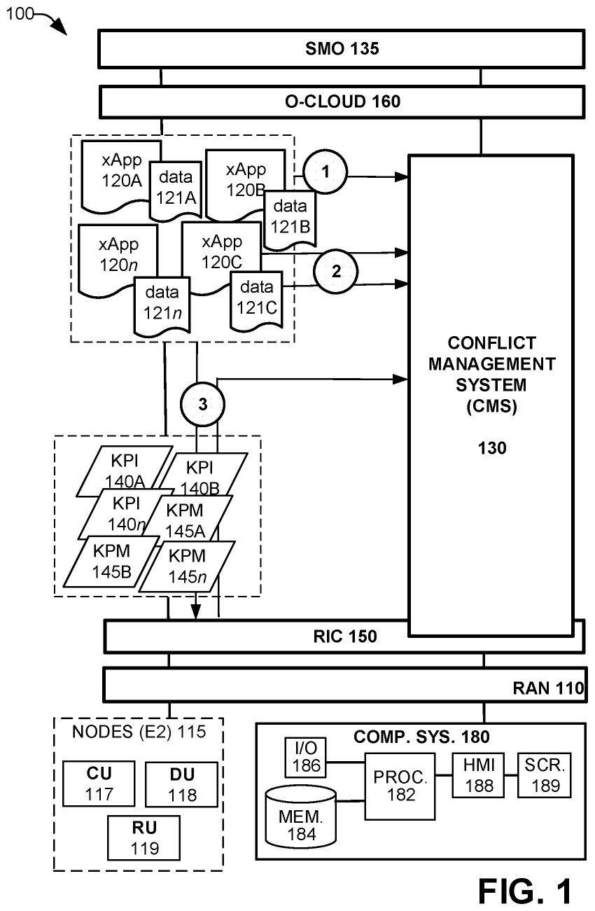

To provide understanding of the various embodiments presented herein, FIG. 1, system 100 presents a high-level overview of some of the systems/components of concern, and various types of interaction/analysis that can be performed regarding conflict management between various xApps deployed on a RAN.

As shown, FIG. 1 presents a RAN 110 for which respective xApps 120A-n can be configured to potentially operate and/or currently operate on. The RAN 110 can include various nodes 115, for example one or more of a CU 117, DU 118, and a RU 119. RAN 110 can be communicatively coupled to a service management orchestration (SMO) layer/component 135, wherein the SMO 135 can be configured to control configuration and automation aspects of respective components/elements of RAN 110 and a RIC 150. The SMO 135 can be further configured to coordinate deployment of respective xApps 120A-n, which, in an example scenario, can involve the SMO 135 operating in conjunction with the RIC 150 regarding the possibility of conflict arising during deployment of respective xApps 120A-n.

The RIC 150 can be configured to control and optimize functions at RAN 110, including onboarding of xApps 120A-n to be operated at the RAN 110. As further described, the RIC 150 can further include a conflict management system (CMS) 130 configured to identify potential and existing conflicts between various xApps 120A-n during potential and current deployment of one or more xApps 120A-n on the RAN 110. As further described, the xApps 120A-n can affect operation of various KPIs 140A-n at the RAN 110, e.g., as determined by key performance metrics KPMs 145A-n. In an ideal situation, the RAN 110 would be configured to support operation of numerous xApps 120A-n. However, deployment of a first application (e.g., xApp 120A) can affect deployment of a second application (e.g., xApp 120B) on the RAN 110, and deleteriously affect one or more of the KPIs 140A-n. As shown in FIG. 1, each xApp 120A-n can be configured with a specific property, use case, metric, etc., for which the xApps 120A-n are respectively designed, with the respective property, use case, etc., of focus for each xApp 120A-n being represented as data 121A-n, wherein respective data 121A-n is associated with a respective xApp 120A-n, e.g., xApp 120A has associated data 121A, xApp 120B has data 121B, xApp 120n has data 121n, etc.

System 100 can further include an O-cloud 160, an infrastructure layer configured to coordinate functions for the RAN 110, SMO 135, and the RIC 150.

FIG. 1 presents three high level scenarios (1) onboarding, (2) subscription/pre-deployment, (3) deployed and operational:
(1) onboarding: an xApp120A is to be deployed on the RAN 110, however, during the onboarding/subscription process of xApp 120A to the RAN 110, the CMS 130 can determine whether the respective one or more operations to be performed by xApp 120A are (i) supported by the RAN 110 and/or (ii) while supported may deleteriously affect operation of the RAN 110 and/or other xApps 120B-n already deployed on the RAN 110. In an event that a target/operation of an xApp 120A is not supported by RAN 110, subscription of the xApp 120A at the RAN 110 can be denied.
(2) subscription/pre-deployment: in the event of xApp 120B can be deployed on the RAN 110, CMS 130 can be configured to determine whether one or more operational conflicts exist between xApp 120B and a deployed/to be deployed xApp 120C. In the event of CMS 130 determines an operational conflict exists between xApp 120B and xApp 120C, various responses can exist such as one of xApp 120B or xApp 120C is not deployed, the xApps are deployed with operation of xAppB prioritized over xAppC, and suchlike, as further described.
(3) deployed and operational: numerous xApp's 120A-n are deployed and operational on RAN 110, whereby the operational effect of one or more of the xApp's 120A-n can be assessed by the CMS 130. Operation of the one or more of the xApp's 120A-n can be assessed based on an impact of a respective xApp 120A-n on operation of one or more KPIs 140A-n and/or KPMs 150A-n. Accordingly, an xApp (e.g., xApp 120N) that is negatively affecting operation of one or more of the KPIs 140A-n and/or operation of any of xApp's 120A-n can be isolated, with operation terminated, delayed, postponed, etc., as further described.

As shown in FIG. 1, CMS 130 and RAN 110 can be communicatively coupled to a computer system 180. The computer system 180 can comprise a processor 182 and a memory 184, wherein the processor 182 can execute the various computer-executable components, functions, operations, etc., presented herein. The memory 184 can be utilized to store the various computer-executable components, functions, code, etc., as well as information regarding any of xApps 120A-n, KPIs 140A-n, KPMs 150A-n, operating condition information of the O-RAN (e.g., RAN 110, RIC 150, SMO 135, as further described), processes 245 (as further described), data 121A-n stored in information database 250 and subscription database 260 (as further described), thresholds, alarms/warnings/notifications, and suchlike.

As further shown, computer system 180 can include an input/output (I/O) component 186, wherein the I/O component 186 can be a transceiver configured to enable transmission/receipt of information and data between any of the components included in system 100. I/O component 186 can be communicatively coupled to the remotely located devices and systems. In an embodiment, I/O component 186 can be configured to transmit various alerts/warnings (e.g., warnings/alarms/information 236A-n) regarding conflict between xApps 120A-n.

In an embodiment, the computer system 180 can further include a human-machine interface (HMI) 188 (e.g., a display, a graphical-user interface (GUI)) which can be configured to present various information including any of xApps 120A-n, associated conflicts and resolutions, etc., per the various embodiments presented herein. The HMI 188 can include an interactive display 189 to present the various information via various screens presented thereon, and further configured to facilitate input of information/settings/etc., regarding the xApps 120A-n.

Per the respective components presented in system 100, conflict mitigation can pertain to detecting, avoiding, and/or addressing conflicting interactions between different xApps 120A-n. Deploying an xApp 120A-n on RAN 110 may involve changing one or more operational parameters at the RAN 110 (or at SMO 135, RIC 150, etc., as further described) with an objective of optimizing a specific metric (e.g., having an associated KPI 140A-n). However, while two or more xApps 120A-n (e.g., a first xApp 120A and a second xApp 120B) may be respectively designed to optimize the same metric, co-deploying the two or more xApps 120A-n may result in conflicting actions. In another scenario, while a first operational objective of xApp 120A and a second operational objective of xApp 120B may be different, co-deploying xApp 120A with xApp 120B may result in conflicting actions that also may adversely affect operation of the RAN 110. Hence, conflict management and resolution are of concern when two or more xApps 120A-n are deployed, particularly where the respective xApps 120A-n are created by different vendors, which can be likely given the disaggregated nature of O-RAN systems.

Per the O-RAN environment presented in FIG. 1, the xApps 120A-n can respectively interact with any of the SMO platform 135, RIC 150 (e.g., controlling interface exposure), and O-cloud 160 components. It is to be appreciated that, to minimize repetition, while the various embodiments presented herein may specifically mention one or more xApps 120A-n being presented/deployed/operate on RAN 110, RIC 150, etc., given that the ubiquitous nature of xApps 120A-n being able to operate on RAN 110, SMO 135, RIC 150, etc., mention of utilization of an xApp 120A-n on any of RAN 110, SMO 135, RIC 150, o-cloud 160, etc., equally applies to application on any of the respective components described herein.

The various embodiments presented herein can be utilized for RT, near-RT, and/or non-RT implementation of RICs, e.g., as present in a conventional RAN architecture. In conventional systems, implementation solutions to address conflicts between xApps 120A-n are not available in near-RT or RT, which the various embodiments presented herein address. The various embodiments presented herein provide a management architecture utilizing the CMS 130 to identify and resolve conflict issues as a function of one or more operational requirements of the RAN 110, operational requirements of respective xApps 120A-n, RIC 150 API requirements, vendor agnostic approaches, and suchlike.

### 1.1. Conflicts Overview

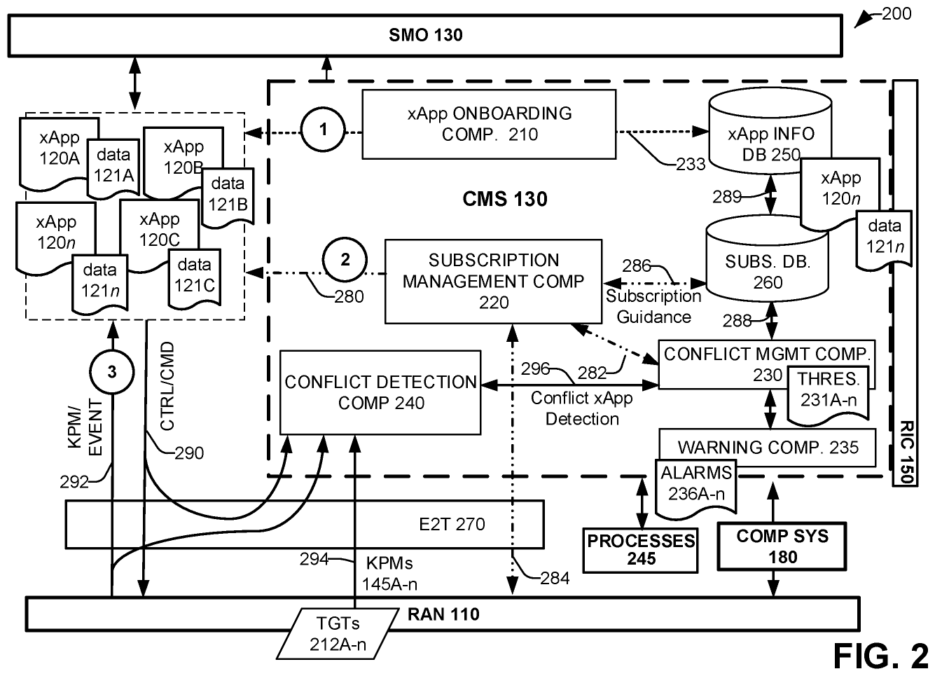

The following provides an overview of some of the conflicts that may be present between various xApps 120A-n deployed on a RAN 110. As mentioned, respective xApps 120A-n can configure a single parameter or a set of parameters to optimize a specific metric (e.g., a KPI 140A-n) at the RAN 110. Each xApps 120A-n can have a specific control target (e.g., target 212A, per FIG. 2). For example, the control target (e.g., target 212A, per FIG. 2) of two or more xApps 120A-n deployed as part of a radio resource management (RRM) application can be a cell, a user equipment (UE), a bearer, and suchlike. Further, the control content of RRM can include access control, bearer control, handover control, resource allocation, quality of service (QoS) control, and suchlike. Furthermore, the control command can have a control time span which indicates the valid control duration. Hence, at any time, a conflict can exist between the control command of the respective xApps 120A-n, e.g., as they pertain to RRM.

As further described, respective conflicts can be categorized as follows:

1.1.a. Direct Conflicts:

A direct conflict can occur between multiple xApps 120A-n, and can be directly observed by CMS 130. The following presents examples of direct conflicts:
i) one or more parameters of control target (e.g., target 212A, per FIG. 2) receive different setting requests through two or more xApps 120A-n. The CMS 130 can be configured to process the respective requests and decides which to operate/execute based on priority and/or other metrics.
ii) a configuration may be currently operating (e.g., a previous request has been executed and an operation is running). A new request from a first xApp (e.g., xApp 120F) may conflict with the previous request from the same xApp (e.g., xApp 120F) or a different xApp (e.g., xApp 120G). Hence, a conflict can be engendered as a function of an addition of a new request in view of a prior request.
iii) the total requested resources from different xApps 120A-n may exceed the limitation of RAN 110-supported resources.

As further described, mitigation of a direct conflict can be achieved by pre-action coordination by CMS 130. Accordingly, the CMS 130 can implement a specific change and/or a sequence of applied changes to prevent a conflict arising between respective xApps 120A-n.

1.1.b. Indirect Conflicts:

Conflicts between multiple xApps 120A-n may not be able to be observed directly. However, some dependencies among the target parameters (e.g., target 212A, per FIG. 2) and resources of different xApps 120A-n can be observed. As further described, CMS 130 can be configured to predict potential conflicts and operate to avoid and/or mitigate a conflict. An example of indirect conflict is where different xApps 120A-n target different parameters to optimize the same metric based on the respective objective of the respective xApps 120A-n. Such a situation may not result in conflicting parameter settings but configuration of a first xApp 120P may impact the system metric (e.g., a target 212A, a KPI 140A, a KPM 145A) which can be equivalent to a parameter change targeted by another xApp 120Q. For example, antenna tilts and cell Individual offset (CIO) are two distinct control actions, wherein an antenna tilt configuration (e.g., target 212A, FIG. 2) is targeted by xApp 120P while cell individual offset (CIO) (e.g., target 212B, FIG. 2) is targeted by xApp 120Q, but both control actions can impact handover function(s).

As further described, mitigation of indirect conflicts can be achieved by post-action verifications. In an example scenario, changes are applied by respective xApps 120A-n, and the target metrics (e.g., KPIs 140A-n) are observed.

1.1.c. Implicit Conflicts:

Such conflicts are not directly visible, and further, the dependencies between multiple xApps 120A-n cannot be directly observed. Essentially, different xApps 120A-n optimize different metrics with different parameters. In such a situation, optimization of a first metric may adversely affect other metrics optimized by other xApps 120A-n. For example, throughput metrics for guaranteed bit rate (GBR) users may degrade metrics of non-GBR users or overall cell throughput.

As further described, mitigation (e.g., by the CMS 130) of implicit conflicts may not be achievable via analytical modeling prior to deploying an xApp 120A-n because operational dependencies between two or more xApps 120A-n can be difficult to predict/observe. Accordingly, AI and ML based coordination schemes (e.g., per implementation of processes 245, as further described) can be utilized at the CMS 130 to identify inter-application dependencies between the two or more xApps 120A-n. In an embodiment, a conflict detection scheme can be provided (e.g., by CMS 130) based on, for example, end-to-end (E2E) system performance and network intent, a specific use case, and suchlike.

In an embodiment, a goal of each xApp 120A-n can be configured prior to providing optimization modelling. However, defining the utility metrics can assist review of an xApps 120A-n in a conflict coordination phase. The utility metrics can include the importance of both targeted metrics and the use case to which the xApps 120A-n pertains. In an embodiment, the CMS 130 can employ various ML-based approaches (e.g., in processes 245, as further described) to pre-assess proposed changes to an xApps 120A-n and/or the operating environment in which the xApps 120A-n is going to operate to estimate the probability of degrading a metric/set of metrics versus the intended improvement to the metric/set of metrics.

It is to be appreciated that while the respective systems, technologies, methods, etc., are presented as providing solutions for RIC 150 conflict management at the near-RT, the systems, etc., equally pertain to other RIC layers (e.g., RT, non-RT). As mentioned, respective xApps 120A-n can provide control/optimization functions to the underlying RAN 110, and accordingly, may be required to avoid contradictory actions when multiple xApps 120A-n are deployed/operational. In an embodiment, the CMS 130 can be designed to accommodate independent xApp 120A-n designs, wherein CMS 130 is vendor agnostic. Per the embodiments presented herein, complexity of conflict management is not limited to independence of different xApps 120A-n. Given the open architecture nature of O-RAN, it is not possible to predict which xApps 120A-n will be deployed together and further, RIC 150 may not know the respective design of each xApp 120A-n. Accordingly, in an embodiment, the CMS 130 can be utilized in a multi-xApps 120A-n interaction framework, as presented in FIG. 2 below.

### 2. PREVENTATIVE MEASURES AND REACTIVE MEASURES

Per the foregoing regarding the issues of unpredictable interaction between xApps 120A-n, respective deployment of xApps 120A-n, the open architecture structure of the RAN 110, etc., the various embodiments presented herein can utilize a combination of preventive (pre-action) measures and reactive (post-action) measures.
2.1. PREVENTIVE measures can be applied to avoid enabling/deploying two or more xApps 120A-n having a direct conflict or overlapping functionality that could deleteriously affect operation of the respective xApps 120A-n, RAN 110, etc. Based on information generated at this stage, preventative measures enable operators to determine a pre-deployment strategy for their respective xApps 120A-n.
2.2. REACTIVE measures can be implemented to detect xApps 120A-n having conflicting decisions, whereby co-deployment leads to changes in KPIs 140A-n by a first xApp (e.g., xApp 120A) and a second xApp (e.g., xApp 120B) that may be opposite, antonymous, incompatible, in nature.

By utilizing preventative measures and/or reactive measures, operators of the xApps 120A-n can be notified (e.g., via HMI 188, warnings 236A-n) of the respective xApp 120A-n interactions (whether in conflict, complimentary, etc.) in conjunction with any recommendations (e.g., ML/AI derived) generated by one or more components (e.g., onboarding component 210, subscription management component 220, conflict detection component 240, conflict management component 230, and suchlike) presented in the respective embodiments herein. Further, post action verifications (e.g., generated by CMS 130) regarding interaction between two or more deployed and operational xApps 120A-n enables operators to adjust a deployment strategy comprising the respective xApps 120A-n.

### 3. CONFLICT MANAGEMENT SYSTEM

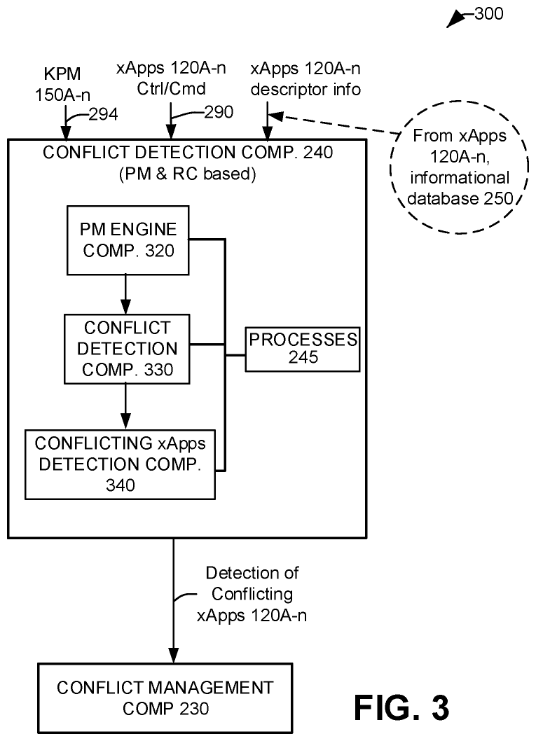

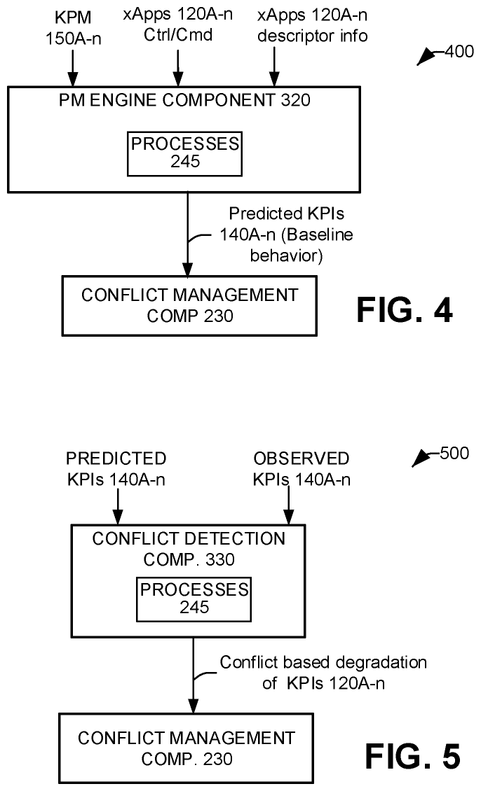

FIG. 2, system 200, illustrates an xApp conflict management architecture, in accordance with an embodiment. As shown, a collection of xApps 120A-n is to be deployed and/or are currently deployed on RAN 110. A CMS 130 can be included in system 200, with CMS 130 being configured to identify and/or resolve any conflicts between xApps 120A-n. The CMS 130 can include an onboarding component 210 communicatively coupled to an xApp information database 250 and a subscription database 260 (e.g., where databases 250 and 260 can be included in memory 184). In another embodiment, CMS 130 can further include a subscription management component 220 coupled to the subscription database 260 and further coupled to a conflict management component 230. As shown in FIG. 2, the subscription management component 220 can be configured to interact with the xApps 120A-n. In a further embodiment, a conflict detection component 240 can be connected to the conflict management component 230, and further connected to any of the RAN 110, E2 Terminal (E2T) 270, and further monitors/interacts with xApps 120A-n. As further described herein (e.g., per FIGS. 4-7), the conflict detection component 240 can be configured with various ML and AI technologies (e.g., FIG. 3, processes 245) to enable detection of conflicts arising from multiple deployed xApps 120A-n. As shown in FIG. 2, information database 250 and subscription database 260 can be respectively connected via connector 289, and subscription database 260 can be connected via connector 288 to the conflict management component 230, such that information regarding xApps 120A-n can be freely shared therebetween. As mentioned, information database 250 and subscription database 260 can be configured to store information (e.g., data 121A-n) previously obtained from previously onboarded/onboard requested xApps 120A-n, wherein the stored data 121A-n can function as historical data against which data (e.g., data 121A) for a current xApp (e.g., xApp 120A) can be compared with. In an embodiment, while shown at conflict management component 230, any of the sub-components of CMS 130 can utilize threshold relationships 231A-n regarding determined likelihood (e.g., likely, not likely, etc.) of conflict between any of xApps 120A-n. CMS 130 can further include a warning component 235 configured to generate and transmit warnings/alerts/notifications 236A-n regarding operation, denied onboarding, etc., of xApps 120A-n.

Interaction and operation of respective components are represented by steps operations (1)-(3), as further described.

At (1), via connection 233, one or xApps 120A-n are being submitted for onboarding/operation on the RAN 110. In an example embodiment, the onboarding component 210 can be configured to receive an xApp 120A (e.g., a first xApp), wherein it is desired to have the xApp 120A-n deployed on the RAN 110. The onboarding component 210 can be configured to review the xApp 120A-n to determine one or more features (e.g., operational features, e.g., in data 121A) of the xApp 120A. The onboarding component 210 can be further configured to compare the one or more features of the xApp 120A with information (e.g., data 121B-n) stored in the xApp information database 250 to determine whether the one or more features of the xApp 120A can be supported by the RAN 110. In an embodiment, in response to a determination that the one or more features of the xApp 120A can be supported by the RAN 110, the onboarding component 210 can be configured to approve onboarding of the xApp 120A, for subsequent deployment of the xApp 120A. In another embodiment, in response to a determination that the one or more features of the xApp 120A cannot be supported by the RAN 110, the onboarding component 210 can be configured to deny onboarding of the xApp 120A.

At (2), prior to deploying a first xApp, e.g., xApp 120A, the first xApp can be reviewed with regard to any potential negative interaction with other xApps 120A-n that may be deployed on RAN 110. As shown, the subscription management component 220 can be configured to interact with xApps 120A-n (e.g., per connection 280), the conflict management component 230 (e.g., via the subscription guidance connection 282), the RAN 110/E2T 370 (e.g., per connection 284), and/or the subscription database 260 (e.g., via connection 286). Prior to deploying an xApp 120A, the respective features (e.g., data 121A) of xApp 120A can be compared with respective features (e.g., data 121B-n) of xApps 120B-n stored in subscription database 260, wherein the xApps 120B-n may be currently deployed or previously deployed on RAN 110. The respective actions/determinations can be conveyed in warnings/alarms 236A-n.

At (3), here respective xApps 120A-n have been deployed, whereby the conflict detection component 240 can be configured to monitor and assess operation of the xApps 120A-n regarding one or more interactions between the respective xApps 120A-n, and further, operational effects of the respective xApps 120A-n on the system components such as RAN 110. In an embodiment, the conflict detection component 240 can monitor interaction(s) between the xApps 120A-n, the RAN 110, and E2T 270, as shown by control/command (CTRL/CMD) connection 290. Further, interaction originating at the RAN 110 (and E2T 270) with the xApp 120-n can be monitored by the conflict detection component 240, as shown by KPM/EVENT connector 292. Further, KPM's 145A-n can be received at the conflict detection component 240 from the RAN 110 (and E2T 370), as shown by KPM connector 294. The conflict detection component 240 can interact with the conflict management component 230, per the conflict xAppn detection connection 296. The respective actions/determinations can be conveyed in warnings/alarms 236A-n.

### 4. CO-DEPLOYMENT AND APPLICATION PRIORITY

In an embodiment, the conflict management component 230 can be configured to control interaction of one or more xApps 120A-n with a component/parameter. In an embodiment, the conflict management component 230 can be configured to determine that a first xApp 120A interacts with a component/parameter (e.g., target 212A) and, further, a second xApp 120B also interacts with the same component/parameter. The conflict management component 230 can be configured to utilize an Application Priority feature. In an embodiment, a first priority setting (e.g., in data 121A) can be applied to the first xApp 120A and a second priority setting (e.g., in data 121B) can be applied xApp 120B. In an embodiment, the priority setting can be configured (e.g., as a utility metric) as part of programming of an xApp 120A-n, a deployment setting configured and applied to the xApp 120A-n at the time of deployment, and suchlike. Accordingly, the conflict management component 230 can be configured to, upon receipt of first xApp 120A having a high priority metric and second xApp 120B having a low priority metric, when high priority xApp 120A issues a command, low priority xApp 120B is blocked from issuing a command(s) within a certain time interval, for example.

The conflict management component 230 can also be configured to adjust xApp 120A-n subscriptions to avoid conflicting control actions being operated by respective xApps 120A-n. The co-deployment rules are not limited to priority assessment, and subscription adjustments and ML based models (e.g., in process 245 in conflict detection component 240) can be trained to provide interventional commands to E2-nodes (e.g., in E2T 270), e.g., CU 117, DU 118, RU 119, etc.

### 5. PREVENTATIVE MEASURES—EXAMPLES

Preventive measures avoid enabling xApps 120A-n having direct conflict or overlapped functionality. Preventative measures allow operators to determine the deployment strategy among such xApps 120A-n. In a conventional O-RAN system, xApp 120A-n specific implementation solutions may not be available to RIC 150 and/or the conflict management component 230. Per the various embodiments presented herein, application of preventative measures can involve defining (e.g., to RIC 150) a set of criteria to gain a high-level understanding of one or more functions of an xApp 120A-n.

### 5.1. Criteria

The criteria can include, in a non-limiting list:

App classification: classification can be based on span level of xApp disaggregation across cloud-edge continuum.

Targeted KPI category and sub-category: the KPI 140A-n categories include coverage, capacity, energy, level, and type of control and suchlike. The KPIs 140A-n related to coverage can include features such as accessibility, retainability, mobility, etc.

The foregoing criteria can be provided by an xApp 120A-n to the RIC 150, e.g., during an onboarding procedure (e.g., as data 121A at onboarding component 210). The criteria provided by the xApp 120A-n can be utilized by the conflict management component 230 to initiate rule-based conflict mitigation strategies (e.g., priority assessment based on utility metric, subscription adjustment, and suchlike, as described herein). A non-limiting list of example conflict mitigation strategies is further provided in 8.3. CONFLICT MANAGEMENT, below.

### 6. REACTIVE MEASURES—EXAMPLES & OPERATION

As mentioned, owing to the potential complexity of interaction between deployed xApps 120A-n, post-action verifications may require targeted ML and AI solutions (e.g., implemented at the conflict detection component 240, via processes 245, as further described) to identify indirect and implicit conflicts. In an embodiment, conflicts between xApps 120A-n may be detected at the RIC 150, e.g., as a function of performance observations (e.g., KPI's 140A-n).

To access observations at the RIC 150, the CMS 130 can be configured to monitor the RAN 110 performance, enabling RIC 150 to act as an “xApp-independent” observer on the xApp 120A-n results. RIC 150 can be configured to determine when a change in KPI 140A-n results from an adverse effect resulting from xApps 120A-n and when the change results from a natural shift in performance of the RAN 110 that is not related to xApps 120A-n. For example, when traffic at the RAN 110 changes, changes in KPIs 140A-n can naturally result/migrate from current RAN 110 control algorithms, accordingly, such natural changes should be identified and understood to establish a change in the baseline behavior of the RAN 110.

As shown in FIG. 3, system 300 presents an xApp conflict management system, in accordance with an embodiment. System 300 can include a conflict detection component 240 comprising a performance management (PM) engine component 320 communicatively coupled to a conflict detection subcomponent 330, which is further communicatively coupled to a conflicting xApps detection component 340. Inputs to the conflict detection component 240 can include KPIs 140A-n and KPMs 150A-n (e.g., per FIG. 2, connector 294), xApps 120A-n CRTL/CMDs (e.g., per FIG. 2, connector 290), and xApps 120A-n descriptor information (e.g., as data 121A-n extracted directly from xApps 120A-n and/or from xApps 120A data in informational database 250). The conflict detection component 240 can further include processes 245 which can be utilized by any the PM engine component 320, conflict detection subcomponent 330, and conflicting xApps detection component 340, (as well as any components in CMS 130). Processes 245 can include any of operations, functions, workflows, etc., as well as ML and AI techniques/technologies configured to detect xApp 120A-n conflicts. Based on the respective inputs into conflict detection component 240, and operation of the PM engine component 320, conflict detection subcomponent 330, and conflicting xApps detection component 340, the conflict detection component 240 can generate one or more detected instances of conflicting xApps 120A-n, as well as any naturally occurring changes in the operation of RAN 110.

Processes 245 can include one or more Recurrent Neural Network (RNN) models which can be utilized to determine whether a change in a KPI 140A-n results from a conflict between multi-xApps 120A-n, or arises as a function of a change (e.g., natural change) in the operational environment of RAN 110 that is independent of interactions between multi-xApps 120A-n. RNN models in processes 245 can also be utilized to forecast a change in performance of a KPI 140A-n, as part of conflict detection by conflict detection component 240. The RIC 150 can be configured to establish correlations between xApp 120A-n actions and change in operational performance of the RAN 110. When multiple xApps 120A-n are working on the same target (e.g., target 212A, per FIG. 2), a prediction of impact on KPIs 140A-n can be a highly complex endeavour, with prediction suitable for implementation of one or more ML techniques in processes 245.

Based on the estimated correlation between xApps 120A-n actions and the performance change of the RAN 110, RIC 150 can identify the xApps 120A-n causing opposite performance direction. To train appropriate ML solutions in processes 245 to detect conflicting applications, xApp 120A-n, classification information can be sourced from the aforementioned inputs: KPIs 140A-n and KPMs 150A-n, xApps 120A-n CRTL/CMDs, xApps 120A-n descriptor information (e.g., data 121A-n), and suchlike.

### 7. CONFLICT MANAGEMENT—EXAMPLES & OPERATION

Conflict management relates to both preventive measures and reactive measures. Primary aspects of both preventive and reactive measures are conflict prediction and conflict detection, respectively. In the preventive measures sections 2.1 and 5, various example rule-based conflict management solutions were presented, wherein the conflict management solutions can be performed after conflicting xApps 120A-n have been detected. Two categories of solutions, Rule-based conflict mitigation and ML-based conflict mitigation (e.g., with processes 245), are further presented and may be used as preventive measures and/or reactive measures.
7.1. Rule-based conflict mitigation strategy can be utilized for situations where xApp 120A-n subscription adjustment can resolve a conflict issue without degrading the performance (e.g., of a KPI 140A-n).

An example rule-based conflict mitigation strategy can be expressed as the following sequence of acts/steps:
1. Trigger specific deployment strategy for conflicting xApps 120A-n;
2. Provide recommendation to adjust the xApps 120A-n;
3. Adjust xApp 120A-n subscriptions to avoid conflicting control actions/subscription guidance; and
4. Specify xApp 120A-n priority among conflicting applications.
7.2. ML based conflict mitigation strategy can be complex and may require complex interaction by processes 245. These methods can be used in situations/cases where blocking or limiting a specific xApp 120A-n could degrade performance of RAN 110 and/or the KPIs 140A-n. With ML-based conflict mitigation strategy, conflict mitigation rules are not limited to priority assessment and subscription adjustments, whereby ML based models (e.g., processes 245) can be trained to provide interventional commands to E2-nodes 115.

### 8. EXAMPLE EMBODIMENTS

### 8.1. Preventative Measures

The following provides an example onboarding procedure of xApps 120A-n. The following procedure can mitigate chance of a direct conflict(s) between an onboarding xApps 120A-n and currently subscribed xApps 120A-n. The respective xApp 120A-n can provide various information/criteria (e.g., as described in Sec. 5.1.) during an onboarding procedure (e.g., to the RIC 150) of the xApp 120A-n with the RAN 110.

The information (e.g., data 121A-n) provided by an xApp 120A-n (e.g., extracted by onboarding component 210) can be compared with current xApp 120A-n subscriptions (e.g., in the subscription database 260 and/or the xApp information database 250) to ensure consistency of operation, and any xApps 120A-n subscription requests which are inconsistent with the current xApps 120A-n can be rejected. The subscription database 260 can include the information structure (e.g., in data 121A-n) of xApps 120A-n deployed on the RAN 110. As a first xApp (e.g., xApp 120A and data 121A) is presented for subscription, the information (e.g., data 121B-n) stored in the subscription database 260 regarding the deployed xApps 120B-n can be used as a reference (e.g., by subscription management component 220, conflict management component 230) to check the consistency of information provided by the first xApp, xApp 120A. In the event of a determination (e.g., by subscription management component 220, conflict management component 230) that the already deployed xApps 120A-n can support operation of xApp 120A, xApp 120A can be subscribed. In the event of a determination (e.g., by subscription management component 220, conflict management component 230) that the already deployed xApps 120A-n do not support/may have a conflict with operating xApp 120A, subscription/operation of the xApp 120A on RAN 110 can be denied (e.g., by the onboarding component 210 or the conflict management component 230). By utilizing information (e.g., historic data 121A-n) already known regarding the deployed xApps 120B-n to check the information/requirement(s) of xApp 120A enables an expeditious review of xApp 120A, which enables the various embodiments presented herein to be applicable to RT and near-RT implementation at RIC 150.

RIC 150 APIs can be used by the xApp 120A-n to access the Information Elements (EIs) of associated E2SMs (E2 Service Models). The RIC 150 provides decoupled APIs from specific implementation solutions. Further, xApps 120A-n can provide the descriptor (e.g., in any of data 121A-n) that includes configuration, control (level and type of control), targeted KPI 140A-n category and sub-category, and xApp classification. The descriptor data provides the necessary data to enable management of the xApp 120A-n including subscription management, conflict management, and orchestration, e.g., based on comparing operational data (e.g., data 121A) of a first xApp (e.g., xApp 120A) with (i) operational data (e.g., data 121B) of a second xApp (e.g., xApp 120B) that was previously or is currently deployed, or (ii) with operational data (e.g., data 121B-n) of multiple xApps (e.g., xApp 120B-n) that were previously or are currently deployed.

The proposed embodiments enable dimensioning, which limits the number of xApps 120A-n allowed to target the same class/KPI 140A-n category. Use of dimensioning reduces the likelihood of untreated conflicts due to co-deployment of xApps 120A-n.

To mitigate potential conflicts, a restrictive framework can be utilized by onboarding component 210 and/or subscription management component 220, whereby onboarding component 210 and/or subscription management component 220 restricts the selection range instead of free selection of all information open to xApps 120A-n. With a restrictive framework approach, onboarding component 210 and/or subscription management component 220 can specify a list of targeted KPIs 140A-n for xApps 120A-n to choose based on xApp 120A-n classifications and it also specifies a list of allowed actions for xApps 120A-n to choose based on the targeted KPIs 140A-n.

### 8.2. Reactive Measures

The following presents further description of structure and operation of the conflict detection component 240. The conflict detection component 240 can be utilized in enabling reactive measures. In an embodiment, to enact reactive measures, firstly the conflicting xApps 120A-n are identified, with the conflict detection component 240 and/or conflict management component 230 subsequently implementing various rule based and ML based conflict mitigation strategies, as previously mentioned in Sec. 7.

As previously mentioned, per FIG. 3, the conflict detection component 240 can include a PM engine component 320 for performance change projection, to enable conflict based on the observed KPI 140A-n and predicted KPI 140A-n (e.g., as KPMs 150A-n) at the conflict detection component 240 to identify the xApps 120A-n leading to opposite performance. FIG. 4, system 400, provides a structural framework of PM Engine component 320. The PM engine component 320 can be configured to utilize processes 245 to predict the KPIs 140A-n in advance using previous KPMs 150A-n, enforced xApps 120A-n control commands, and xApps 120A-n descriptor information (e.g., in data 121A-n) including the proposed criteria (e.g., as presented in section 5.1.). In an embodiment, predicted KPIs 140A-n can be generated by PM engine component 320 and used as baseline behavior (e.g., by the conflict management component 230) to detect any potential performance degradation arising from conflict between xApps 120A-n.

FIG. 5, system 500, presents a high level structure of conflict detection subcomponent 330, in accordance with an embodiment. As shown in FIG. 5, predicted KPIs 140A-n and observed KPIs 140A-n can be inputted into the conflict detection subcomponent 330, whereby the conflict detection subcomponent 330 can be configured to determine if any conflicts exist between the xApps 120A-n that have been accepted for deployment and/or are currently being deployed on RAN 110. Any potential correlation existing between a set of provided predicted KPIs 140A-n and observed KPIs 140A-n can be identified by one or more ML models in processes 245, from which, existence of conflict between xApps 120A-n can be identified in conjunction with estimation of any degradation in the KPIs 140A-n arising from the conflict between the xApps 120A. Any identified degradation in KPIs 120A-n can be utilized by the conflict management component 230.

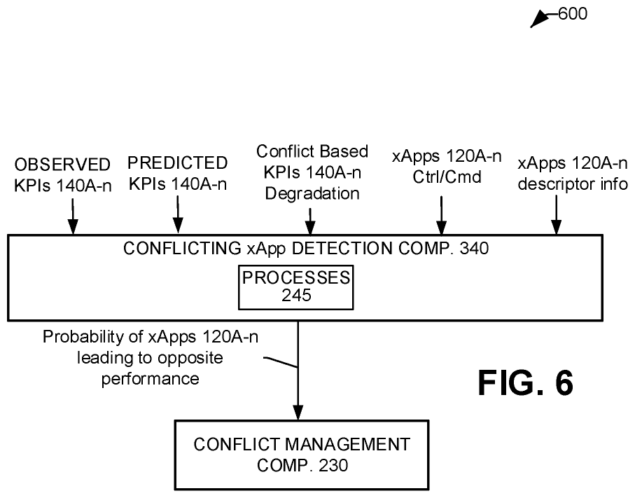

In the event of a conflict being detected between xApps 120A-n during post monitoring, the source of the conflict between xApps 120A-n can be identified. FIG. 6, system 600 presents a structural framework for conflicting xApps detection component 340 configured to detect conflicting xApps 120A-n, in accordance with an embodiment. The conflicting xApps detection component 340 can be configured to identify one or more correlations between respective operations of xApps 120A-n and a corresponding change in performance of the KPIs 140A-n. The conflicting xApps detection component 340 can be further configured to determine an xApp (e.g., xApp 120A) that leads to opposite/negative performance direction using such inputs as observed KPIs 140A-n, predicted KPIs 140A-n, conflict based degraded KPIs 140A-n, accepted xApps 120A-n control commands, xApp 120A-n descriptor info, and suchlike. As shown in FIG. 6, output of the conflicting xApps detection component 340 can be a probability of xApps 120A-n leading to opposite performance, with the output being an input into the conflict management component 230.

### 8.3. Conflict Management

For ML based mitigation strategy, any suitable ML technique can be utilized at processes 245, such as reinforcement learning (RL) models. One or more RL models can be configured to choose the control command that leads to the highest performance of KPIs 140A-n. In an example RL model implementation, the reference action space can be defined as a union of conflicting xApps' 120A-n list of proposed actions. The reward is set as a weighted function of conflicting xApps' 120A-n targeted KPIs 140A-n. The targeted KPIs 140A-n can be based on a strategy implemented by an operator of RAN 110, a defined utility function, and suchlike.

An example RL based mitigation algorithmic framework can be provided as follows:
1. Define the state space as idle/active state of subscribed conflicting xApps 120A-n (here defined as xApp v) and associated targeted KPI 140A-n values:

s^{t}={U_{v∈V}oᵥ^{t},Γᵥ^{t}},
where oᵥ^{t} is the targeted KPI value for xApp v and Γᵥ^{t} is idle/active state indicator of xApp v at time t and V is a set of conflicting xApps (e.g., xApps 120B-n conflicting with xApp 120A).
2. Define a reference action space as a union of conflicting xApps' list of proposed actions:

a^{t}=U_{v∈V}ãᵥ^{t},
where ãᵥ^{t} is the proposed action by xApp v at time t.
3. Set the reward as a weighted function of conflicting xApps' targeted KPIs 140A-n based on operators' strategy or defined utility function:

r^{t}=Σ^{v∈V}wᵥoᵥ^{t},
where r^{t} is the reward value at time t.
4. Implement any suitable ML (e.g., reinforcement learning (RL) such as Deep Q Network (DQN) methodology) (e.g., in processes 245) to find the action which maximizes the reward.

For the scenarios in which the action spaces of all conflicting xApps 120A-n are logical (e.g., turning on/off, decreasing/increasing guidance, and suchlike) the foregoing approach/methodology can be modified to improve overall performance. Accordingly, the selected action from the winner xApp (e.g., xApp 120A-n) may be different from the proposed action by that specific xApp (e.g., xApp 120A-n). In an embodiment, the conflict management component 230 can be configured to select a logical action from the list of allowed actions which contrasts with the proposed action by the winner xApp (e.g., xApp 120A).

The state space and action space of a modified RL based mitigation algorithm can be defined as:
i) define the state space as idle/active state of subscribed conflicting xApps 120A-n and the targeted KPI 140A-n values, and proposed actions by each xApp 120A-n. The following utilizes the term:

s^{t}={U_{v∈V}oᵥ^{t},Γᵥ^{t},ãᵥ^{t}},
where oᵥ^{t} is the targeted KPI 140A-n value for xApp v, Γᵥ^{t} is idle/active state indicator of xApp v, ãᵥ^{t} is the proposed action by xApp v at time t and V is a set of conflicting xApps.
ii) define a reference action space as a union of conflicting xApps' list of allowed actions:

a^{t}=U_{V∈V}aᵥ^{t},
where aᵥ^{t} is set of allowed actions for xApp v at time t.

As mentioned, various processes 245 can be configured to determine information, make predictions, etc., regarding operational conflict between two or more xApps 120A-n. As previously mentioned, the processes 245 can include AI, ML and reasoning techniques/technologies that employ probabilistic and/or statistical-based analysis to prognose or infer an action that a user desires to be automatically performed. The various embodiments presented herein can utilize various ML-based schemes for carrying out various aspects thereof, e.g., potential conflict between a first xApp 120A and a second xApp 120B, and further, conflicts between respective xApps 120A-n operated on the RAN 110, which as mentioned, can be facilitated via an automatic classifier system and process.

As used herein, the terms “predict”, “infer”, “inference”, “determine”, and suchlike, refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

In the various embodiments presented herein, the CMS 130 can obtain operational data (e.g., data 121A-n, KPIs 140A-n, KPMs 150A-n) from the xAPPs 120A-n regarding the parameters, metrics, use cases, etc., that the respective xAPP 120A-n is configured to control/adjust. The processes 245 can include AI, ML and reasoning techniques/technologies that employ probabilistic and/or statistical-based analysis to prognose or infer an action that a user desires to be automatically performed. The various embodiments presented herein can utilize various ML-based schemes for carrying out various aspects thereof, e.g., determining presence of conflicts between xAPPs 120A-n, as previously mentioned herein, can be facilitated via an automatic classifier system and process.

A classifier is a function that maps an input attribute vector, x=(x1, x2, x3, x4, xn), to a class label class(x). The classifier can also output a confidence that the input belongs to a class, that is, f(x)=confidence(class(x)). Such classification can employ a probabilistic and/or statistical-based analysis (e.g., factoring into the analysis utilities and costs) to prognose or infer an action that a user desires to be automatically performed (e.g., conflict resolution between xApps 120A-n).

A support vector machine (SVM) is an example of a classifier that can be employed. The SVM operates by finding a hypersurface in the space of possible inputs that splits the triggering input events from the non-triggering events in an optimal way. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein is inclusive of statistical regression that is utilized to develop models of priority.

As will be readily appreciated from the subject specification, the various embodiments can employ classifiers that are explicitly trained (e.g., via a generic training data) as well as implicitly trained (e.g., via observing behavior of xApps 120A-n, RAN 110 behavior, receiving extrinsic information, and suchlike). For example, SVM's are configured via a learning or training phase within a classifier constructor and feature selection module. Thus, the classifier(s) can be used to automatically learn and perform a number of functions, including but not limited to determining according to predetermined criteria, e.g., whether an operational conflict exists, performance of KPIs 140A-n, operational goal(s) of respective xApps 120A-n, direct conflicts, indirect conflicts, implicit conflicts, and suchlike.

As described supra, inferences can be made, and operations performed, based on numerous pieces of information. For example, information/data (e.g., data 121A-n) regarding operating xApps 120A-n, historical usage, predicted usage, etc., as operation of the xApps 120A-n continues, enabling analysis to determine converging patterns such that inferences can be made regarding powering conflict between respective xApps 120A-n.

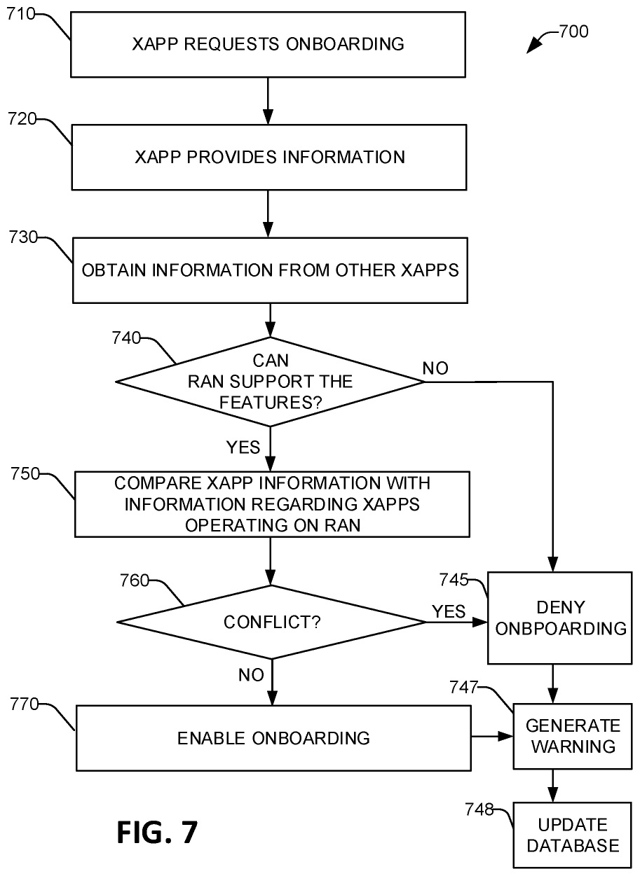

FIG. 7, illustrates methodology 700 for determining whether an operational conflict arises by operating/executing an xApp on a RAN, in accordance with one or more embodiments described herein.

At 710, a first xApp (e.g., xApp 120A) requests to be onboarded onto a RAN (e.g., RAN 110) to enable the xApp to control one or more parameters, use cases, etc., on the RAN.

At 720, the first xApp can be configured to provide first information (e.g., data 121A) to an onboarding component (e.g., onboarding component 210). The first information can detail which parameter, use case, metric, KPI (e.g., any of KPIs 140A-n), and suchlike, the first xApp is being deployed to adjust.

At 730, in an embodiment, other information can be obtained (e.g., by the onboarding component 210) from other xApps (e.g., xApps 120A-n were presented for onboarding, were onboarded, deployed, etc.), wherein the other information can be stored (e.g., by the onboarding component 210) in a database (e.g., database 250, subscription database 260). For example, second information pertaining to a second xApp can be stored in the database, and subsequently compared with the first information of the first xApp.

At 740, the first information can be compared with an operational configuration information of the RAN to determine whether the xApp can be supported by the RAN. In an embodiment, the operational configuration information for the RAN can be derived from the respective xApps that are currently deployed/previously deployed at the RAN. For example, the first information of the first xApp can be compared with the information (e.g., data 121B-n) available from the other xApps (e.g., xApps 120B-n). Based thereon, it may be possible to determine what the RAN can support based on the information (e.g., data 121B-n) in terms of what other xApps were denied onboarding (e.g., by the onboarding component 210). In the event of a determination that NO, the RAN is unable to support the first xApp, methodology 700 can advance to 745 where the first xApp can be denied onboarding (e.g., by the onboarding component 210). At 747, a warning (e.g., warning 236A-n) can be generated by a warning component (e.g., warning component 235) to inform an entity such as a network operator of the denied onboarding of the first xApp. At 748, a database (e.g., either of databases 250 and/or 260) can be updated with the respective information (e.g., data 121A) regarding the first xApp being denied onboarding.

At 740, in the event of the RAN is determined (e.g., by the onboarding component 210) to be able to support the first xApp, methodology 700 can advance to 750. At 750, the first information (e.g., data 121A) regarding the first xApp can be compared with the other information (e.g., data 121B-n) to determine (e.g., by subscription management component 220 in conjunction with conflict management component 230) whether the first xApp conflicts with other any of the other xApps. For example, the first information (e.g., data 121A) of the first xApp (e.g., xApp 120A) can be compared with second information (e.g., data 121B) of a second xApp (e.g., xApp 120B) to determine whether a conflict exists.

At 760, a determination (e.g., by conflict management component 230) can be made regarding whether a conflict exists between the first xApp and the second xApp. In the event of YES, a conflict exists, the first xApp can be denied subscription to the RAN, with methodology 700 returning to 745, as previously described, wherein the warning(s) and database updates can be configured to convey the conflict between the first xApp and the second xApp.

At 760, in the event of a determination (e.g., by conflict management component 230) that there is no conflict between the first xApp and the second xApp, methodology can advance to 770, whereupon the first xApp can be onboarded (e.g., by the subscription management component 220) onto the RAN. Methodology 700 can return to 747, as previously described, wherein, in an embodiment, an indicator (e.g., an alarm 236A-n) can be generated and transmitted (e.g., by warning(s) component 235) and, further, at 748, the database (e.g., either of databases 250 and/or 260) updated (e.g., data 121A-n) to indicate the first xApp was onboarded/deployed/operated/executed, with no conflict between the first xApp and the second xApp.

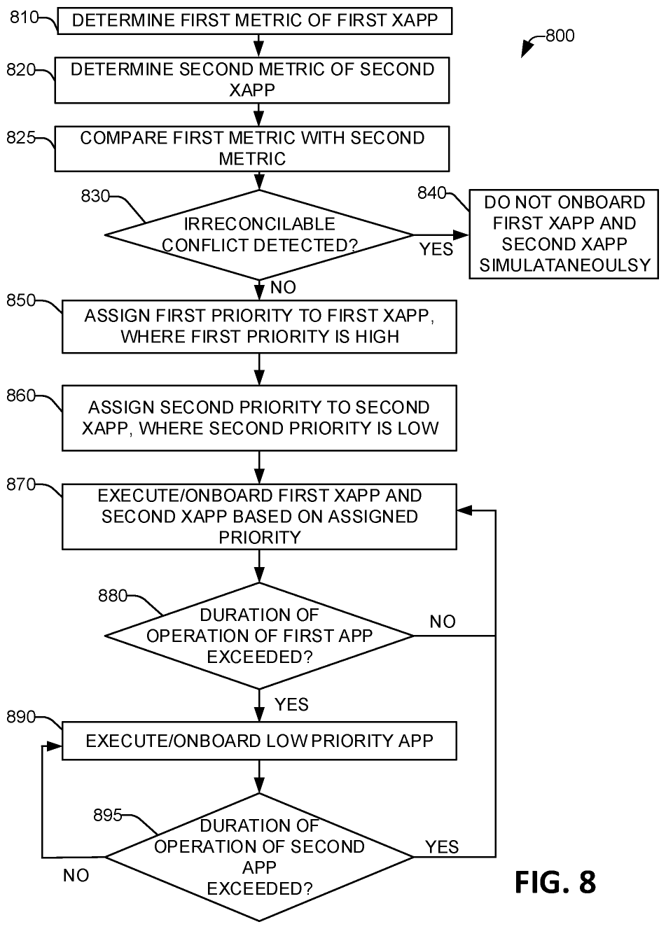

FIG. 8, illustrates methodology 800 for determining whether an operational conflict arises by operating/executing an xApp on a RAN, in accordance with one or more embodiments described herein.

At 810, as previously described, a first xApp (e.g., xApp 120A) can be configured to provide first information (e.g., data 121A) to a subscription component (e.g., subscription management component 220). The first information can detail which metric, parameter, use case, KPI (e.g., any of KPIs 140A-n), and suchlike, the first xApp is being deployed to adjust (e.g., target 212A).

At 820, a second xApp (e.g., xApp 120B) can be configured to provide second information (e.g., data 121B) to a subscription component (e.g., subscription management component 220). The second information can detail which metric, parameter, use case, KPI (e.g., any of KPIs 140A-n), and suchlike, the second xApp is deployed to adjust.

At 825, the first metric to be adjusted by the first xApp can be compared (e.g., by conflict management component 230) with the second metric to be adjusted by the second xApp. In an embodiment, the first metric and the second metric can have a common control target (e.g., target 212A).

At 830, the presence of a conflict on the RAN (e.g., RAN 110) and the magnitude of the conflict can be determined by a conflict component (e.g., conflict management component 230). In the event of operation of the first xApp would deleteriously affect operation of the second xApp regarding control of the common target, a further determination can be made, e.g., by the conflict component, regarding whether the first xApp and the second xApp might be able to co-exist. In the event of the conflict would lead to the second xApp not being able to effectively control the common target, methodology 800 can advance to 840, whereupon the first xApp can be denied (e.g., by conflict management component 230) simultaneous operation with the second xApp on the RAN.

At 830, in the event of operation of the first xApp may negatively affect control of the target by the second xApp, but the first xApp and second xApp can be configured to be co-deployed on the RAN, methodology 800 can advance to 850.

At 850, a first priority of operation can be assigned (e.g., by subscription management component 220) to the first xApp (e.g., as part of data 121A), wherein the priority can be assigned a first level, e.g., “high”.

At 860, a second priority of operation can be assigned (e.g., by subscription management component 220) to the second xApp (e.g., as part of data 121B), wherein the priority can be assigned a second level, e.g., “low”.

At 870, the first xApp and the second xApp can respectively operate on the RAN based on their respective first priority and second priority. In an embodiment, the first priority can be used to control operation when the first xApp operates when information pertaining to the first metric is present at the RAN, otherwise the lower priority, second xApp is operated. In another embodiment, the first priority and second priority can be established based on time. For example, the first xApp is configured to operate for a first duration, and then the second xApp is configured to operate for a second duration.

At 880, with the first xApp operating based on the first priority, the duration of operation of the first xApp can be monitored. In the event of the first duration of operation has yet to expire, methodology 800 can return to 870 to further monitor operation of the first xApp.

At 880, in the event of the first duration of operation having expired, methodology 800 can advance to 890, for operation of the low priority, second xApp having the second duration.

At 895, with the second xApp operating based on the second priority, the duration of operation of the second xApp can be monitored. In the event of the second duration of operation has yet to expire, methodology 800 can return to 890 to further monitor operation of the second xApp. At 895, in the event of the second duration of operation having expired, methodology 800 can return to 870, for re-operation of the first xApp having the first duration.

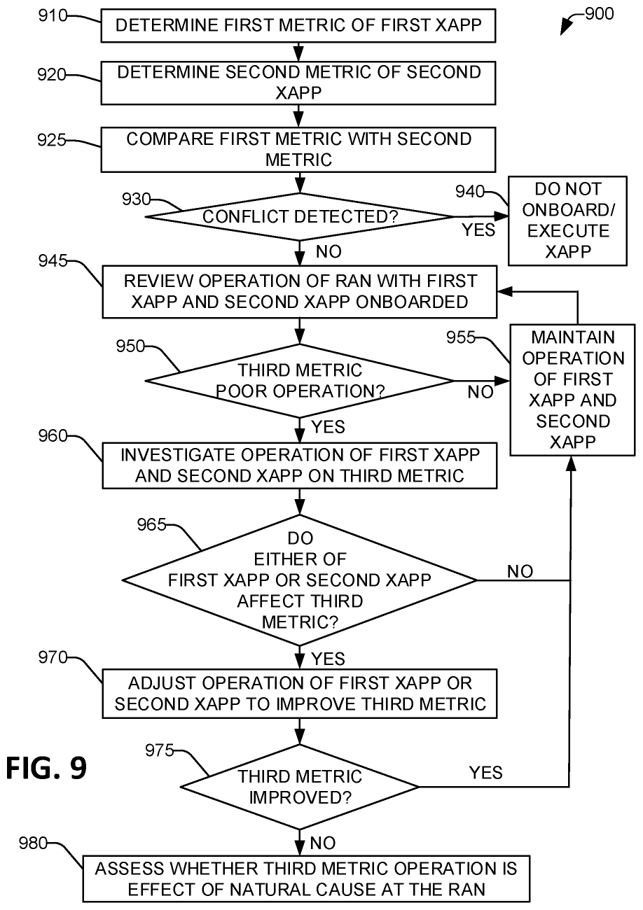

FIG. 9, illustrates methodology 900 for determining whether an operational conflict arises by operating/executing an xApp on a RAN, in accordance with one or more embodiments described herein.

At 910, as previously described, a first xApp (e.g., xApp 120A) can be configured to provide first information (e.g., data 121A) to a subscription component (e.g., subscription management component 220). The first information can detail which metric, parameter, use case, KPI (e.g., any of KPIs 140A-n), and suchlike, the first xApp is being deployed to adjust (e.g., target 212A).

At 920, a second xApp (e.g., xApp 120B) can be configured to provide second information (e.g., data 121B) to a subscription management component (e.g., subscription management component 220). The second information can detail which metric, parameter, use case, KPI (e.g., any of KPIs 140A-n), and suchlike, the second xApp is deployed to adjust (e.g., also target 212A).

At 925, operation of the first xApp can be requested. The first metric to be adjusted by the first xApp can be compared (e.g., by conflict management component 230) with the second metric to be adjusted by the second xApp. In an embodiment, the first metric and the second metric can have a common control target (e.g., target 212A).

At 930, the presence of a conflict on the RAN (e.g., RAN 110) can be determined by a conflict component (e.g., conflict management component 230). In the event of operation of the first xApp would deleteriously affect operation of the second xApp regarding control of the common target, methodology 900 can advance to 940, where the first xApp can be denied (e.g., by conflict management component 230) operation on the RAN.

At 930, in the event of a determination that NO, operation of the first xApp would not negatively affect control of the target by the second xApp, methodology 900 can advance to 945. In an embodiment, the first xApp and the second xApp can be considered to be disparate.

At 945, operation of the RAN can be reviewed in view of the first xApp and the second xApp being co-deployed. As previously mentioned, direct conflicts between co-operation of xApps may be readily discernible, however, indirect and implicit conflicts may be harder to detect/identify. In an embodiment, other metrics, e.g., a third metric, may be impacted by the operation of the first xApp and the second xApp. Operation of the third metric can be monitored to see if the third metric is negatively affected by the co-deployment of the first xApp and the second xApp.

At 950, a determination can be made regarding the operation of the third metric, for example, is the third metric operating worse than when compared to a prior situation where the first xApp and the second xApp were not co-deployed? In the event of a determination that the co-deployment of the first xApp and the second xApp does NOT adversely affect the third metric, methodology 900 can advance to 955, whereupon the co-deployment of the first xApp and the second xApp can be maintained. Step/act 955 can further return to 945 for further/subsequent determination of whether the co-deployment of the first xApp and the second xApp affects operation of the RAN. Accordingly, the RAN can be continually monitoring operation thereon to detect a conflict that may not be present when the first xApp and the second xApp are co-deployed, but rather, the conflict develops/reveals itself over time.

At 950, in the event of a determination that YES, the co-deployment of the first xApp and the second xApp does adversely affect the third metric, methodology 900 can advance to 960 to determine effects of the co-deployed first xApp and the second xApp (singly or in combination) on the third metric.

At 965, in the event of, NO, the first xApp and/or the second xApp are not responsible for the poor operation of the third metric, methodology 900 can return to 955 for further monitoring of the co-deployed first xApp and the second xApp, as previously mentioned.

At 965, in the event of, YES, the first xApp and/or the second xApp are affecting operation of the third metric, methodology 900 can advance to 970, whereupon analysis can be conducted by the conflict detection component (e.g., conflict detection component 240) to adjust operation to the co-deployed first xApp and the second xApp to isolate the respective effects of the first xApp and the second xApp on the third metric.

At 975, in the event of a determination that YES, adjustment of the first xApp and/or the second xApp can have an effect (e.g., beneficial) on the third metric, methodology 900 can return to 955, whereupon the modified operation of the first xApp and/or the second xApp can be maintained.

At 975, in the event of a determination that NO, adjustment of the first xApp and/or the second xApp are not affecting the third metric, methodology 900 can advance to 980, whereupon further analysis can be performed to determine whether the effect on operation of the third metric is a result of a natural change in the RAN, as previously mentioned.

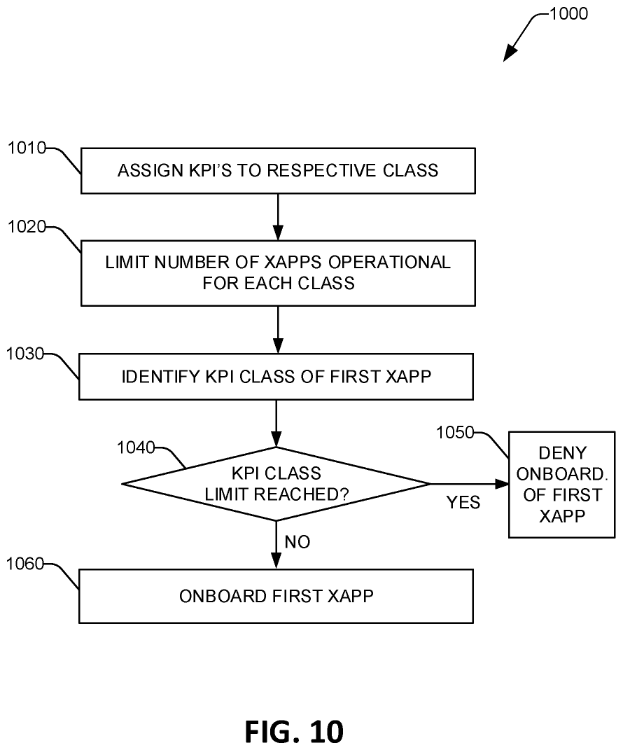

FIG. 10, illustrates methodology 1000 for deploying an xApp on a RAN based on KPI class, in accordance with one or more embodiments described herein.

At 1010, respective KPIs can be separated into classes, whereby each KPI can have its own class.

At 1020, to prevent an excessive number of xApps (e.g., xApps 120A-n) being assigned to a particular KPI (e.g., KPIs 140A-n, such as a metric, use case, etc., and/or each of targets 212A and 212B), each KPI can be assigned a maximum number of xApps that can operate on that KPI. Limiting the number of xApps that can be associated with a particular KPI can limit the likelihood of conflict between xApps operating with the particular KPI.

At 1030, as an xApp is requesting operation (e.g., as part of subscription), the KPI/metric (e.g., a first metric) of focus of the xApp can be identified (e.g., in data 121A) by an onboarding component (e.g., onboarding component 210).

At 1040, a determination can be made, e.g., by the onboarding component, as to whether the number of xApps that can be assigned to a particular KPI has been reached. E.g., has the maximum number of xApps that can be assigned to the first KPI/metric been reached? In the event of a determination that YES, the maximum number of xApps for the first KPI/metric has been reached, methodology 1000 can advance to 1050, whereupon the requesting onboarding xApp (e.g., xApp 120A) can be denied operation by the onboarding component.

At 1040, in the event of a determination that NO, the maximum number of xApps for the first KPI/metric has not been reached, methodology 1000 can advance to 1060, whereupon the requesting onboarding xApp (e.g., xApp 120A) can be granted operation on the RAN by the onboarding component.

### 9. EXAMPLE ENVIRONMENTS OF USE

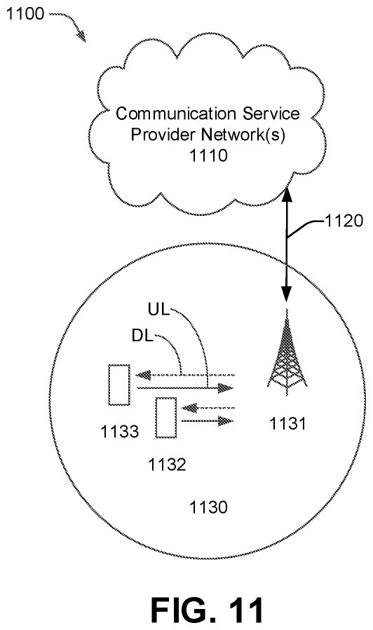

FIG. 11 illustrates an example wireless communication system 1100, in accordance with one or more embodiments described herein. The example wireless communication system 1100 comprises communication service provider network(s) 1110, a network node 1131, and user equipment (UEs) 1132, 1133. A backhaul link 1120 connects the communication service provider network(s) 1110 and the network node 1131. The network node 1131 can communicate with UEs 1132, 1133 within its service area 1130. The dashed arrow lines from the network node 1131 to the UEs 1132, 1133 represent downlink (DL) communications to the UEs 1132, 1133. The solid arrow lines from the UEs 1132, 1133 to the network node 1131 represent uplink (UL) communications.

In general, with reference to FIG. 11, the non-limiting term “user equipment” can refer to any type of device that can communicate with network node 1131 in a cellular or mobile communication system 1100. UEs 1132, 1133 can have one or more antenna panels having vertical and horizontal elements. Examples of UEs 1132, 1133 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 1132, 1133 can also comprise IoT devices that communicate wirelessly.

In various embodiments, system 1100 comprises communication service provider network(s) 1110 serviced by one or more wireless communication network providers. Communication service provider network(s) 1110 can comprise a “core network”. In example embodiments, UEs 1132, 1133 can be communicatively coupled to the communication service provider network(s) 1110 via a network node 1131. The network node 1131 can communicate with UEs 1132, 1133, thus providing connectivity between the UEs 1132, 1133 and the wider cellular network. The UEs 1132, 1133 can send transmission type recommendation data to the network node 1131. The transmission type recommendation data can comprise a recommendation to transmit data via a closed loop multiple input multiple output (MIMO) mode and/or a rank-1 precoder mode.

Network node 1131 can have a cabinet and other protected enclosures, computing devices, an antenna mast, and multiple antennas for performing various transmission operations (e.g., MIMO operations) and for directing/steering signal beams. Network node 1131 can comprise one or more base station devices which implement features of the network node. Network nodes can serve several cells, depending on the configuration and type of antenna. In example embodiments, UEs 1132, 1133 can send and/or receive communication data via wireless links to the network node 1131.

Communication service provider networks 1110 can facilitate providing wireless communication services to UEs 1132, 1133 via the network node 1131 and/or various additional network devices (not shown) included in the one or more communication service provider networks 1110. The one or more communication service provider networks 1110 can comprise various types of disparate networks, including but not limited to: cellular networks, femto networks, picocell networks, microcell networks, internet protocol (IP) networks Wi-Fi service networks, broadband service network, enterprise networks, cloud-based networks, millimeter wave networks and the like. For example, in at least one implementation, system 1100 can be or comprise a large-scale wireless communication network that spans various geographic areas. According to this implementation, the one or more communication service provider networks 1110 can be or comprise the wireless communication network and/or various additional devices and components of the wireless communication network (e.g., additional network devices and cell, additional UEs, network server devices, etc.).

The network node 1131 can be connected to the one or more communication service provider networks 1110 via one or more backhaul links 1120. The one or more backhaul links 1120 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 1120 can also comprise wireless link components, such as but not limited to, line-of-sight (LOS) or non-LOS links which can comprise terrestrial air-interfaces or deep space links (e.g., satellite communication links for navigation). Backhaul links 1120 can be implemented via a “transport network” in some embodiments. In another embodiment, network node 1131 can be part of an integrated access and backhaul network. This may allow easier deployment of a dense network of self-backhauled 5G cells in a more integrated manner by building upon many of the control and data channels/procedures defined for providing access to UEs 1132, 1133.

Wireless communication system 1100 can employ various cellular systems, technologies, and modulation modes to facilitate wireless radio communications between devices (e.g., the UEs 1132, 1133 and the network node 1131). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 1100 can operate in accordance with any 5G, next generation communication technology, or existing communication technologies, various examples of which are listed supra. In this regard, various features and functionalities of system 1100 are applicable where the devices (e.g., the UEs 1132, 1133 and the network node 1131) of system 1100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g., interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 1100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example, several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 9 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The embodiments illustrated herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

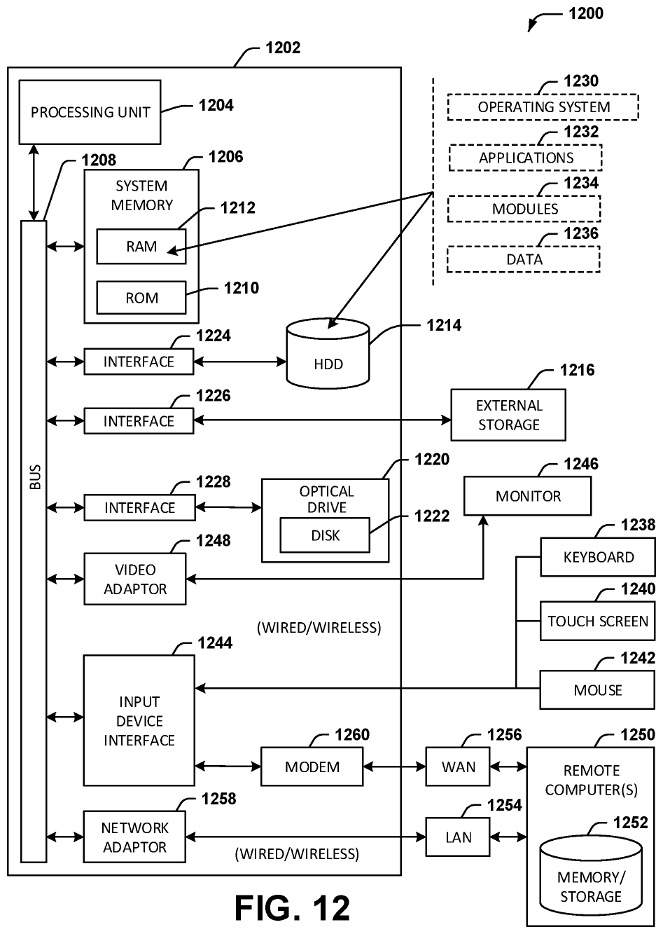

With reference to FIG. 12, the example environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors and may include a cache memory. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1150 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in environment 1200, a solid-state drive (SSD) could be used in addition to, or in place of, an HDD 1214. The HDD 1214, external storage device(s) 1216 and optical disk drive 1250 can be connected to the system bus 1208 by an HDD interface 1224, an external storage interface 1226 and an optical drive interface 1228, respectively. The interface 1224 for external drive implementations can include at least one or both of Universal Serial Bus (USB) and Institute of Electrical and Electronics Engineers (IEEE) 1294 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally comprise emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can comprise one virtual machine (VM) of multiple VMs hosted at computer 1202. Furthermore, operating system 1230 can provide runtime environments, such as the Java runtime environment or the .NET framework, for applications 1232. Runtime environments are consistent execution environments that allow applications 1232 to run on any operating system that includes the runtime environment. Similarly, operating system 1230 can support containers, and applications 1232 can be in the form of containers, which are lightweight, standalone, executable packages of software that include, e.g., code, runtime, system tools, system libraries and settings for an application.

Further, computer 1202 can comprise a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1240, and a pointing device, such as a mouse 1242. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1244 that can be coupled to the system bus 1208, but can be connected by other interfaces, such as a parallel port, an IEEE 1294 serial port, a game port, a USB port, an IR interface, a BLUETOOTH® interface, etc.

A monitor 1246 or other type of display device can be also connected to the system bus 1208 via an interface, such as a video adapter 1248. In addition to the monitor 1246, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN) 1254 and/or larger networks, e.g., a wide area network (WAN) 1256. Such LAN and WAN networking environments are commonplace in offices and companies, and facilitate enterprise-wide computer networks, such as intranets, all of which can connect to a global communications network, e.g., the internet.

When used in a LAN networking environment, the computer 1202 can be connected to the local network 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1260 or can be connected to a communications server on the WAN 1256 via other means for establishing communications over the WAN 1256, such as by way of the internet. The modem 1260, which can be internal or external and a wired or wireless device, can be connected to the system bus 1208 via the input device interface 1244. In a networked environment, program modules depicted relative to the computer 1202 or portions thereof, can be stored in the remote memory/storage device 1252. It will be appreciated that the network connections shown are examples and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1260, respectively. Upon connecting the computer 1202 to an associated cloud storage system, the external storage interface 1226 can, with the aid of the adapter 1258 and/or modem 1260, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities. The terms “set” and “group” are used interchangeably herein.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B, eNB),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments are described herein in the context of 5G, O-RAN, or other generation networks, the disclosed aspects are not limited to 5G or O-RAN implementations, and can be applied in other network next generation implementations, such as sixth generation (6G), or other wireless systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), 5G, third generation partnership project 2 (3GPP2), ultra-mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
receiving, by a device comprising a processor, a request to onboard a first application (xApp), wherein the first xApp is configured to adjust a first metric of a radio access network (RAN); and
determining, by the device, whether adjustment of the first metric causes a conflict with current operation of the RAN.

2. The method according to claim 1, further comprising:
determining, by the device, whether the RAN is able to support adjustment of the first metric by the first xApp; and
in response to the RAN being determined to be unable to support adjustment of the first metric by the first xApp, denying, by the device, an onboarding request from the first xApp to operate the first xApp at the RAN.

3. The method according to claim 1, further comprising:
determining, by the device, a second metric adjusted by a second xApp, wherein the first metric of the first xApp and the second metric of the second xApp have a common control target; and
in response to determining, by the device, the first metric of the first xApp and the second metric of the second xApp have a common control target, further determining, by the device, whether the first metric of the first xApp deleteriously affects operation of the common control target as a function of operation of the common control target adjusted by the second metric of the second xApp.

4. The method according to claim 3, further comprising:
in response to the first metric of the first xApp being determined to be deleteriously affecting the operation of the common control target as a function of the operation of the common control target adjusted by the second metric of the second xApp, denying, by the device, an onboarding request from the first xApp to operate the first xApp at the RAN.

5. The method according to claim 3, further comprising:
in response to the first metric of the first xApp being determined to be deleteriously affecting the operation of the common control target as a function of the operation of the common control target adjusted by the second metric of the second xApp, applying, by the device, a first priority to the first xApp and a second priority to the second xApp, wherein the first priority has a higher priority than the second priority;
based on the higher priority, executing, by the device, the first xApp;
terminating, by the device, operation of the first xApp; and
executing, by the device, the second xApp.

6. The method according to claim 5, wherein the operation of the first xApp is terminated based on a configured duration of time.

7. The method according to claim 1, further comprising:
identifying, by the device, a second metric adjusted by a second xApp, wherein the first metric and the second metric are disparate; and
determining, by the device, that a third metric operating at the device is being negatively affected by an interaction resulting from the first metric being adjusted by the first xApp and the second metric being adjusted by the second xApp.

8. The method according to claim 7, further comprising:
terminating, by the device, execution of the first xApp.

9. The method according to claim 1, wherein the RAN is an open-RAN (O-RAN).

10. A system, comprising:
at least one processor; and
a memory coupled to the at least one processor and having instructions stored thereon, wherein, in response to the at least one processor, the instructions facilitate performance of operations, comprising:
identifying a first metric of a radio access network (RAN) being controlled by a first application (xApp);
identifying a second metric of the RAN being controlled by a second xApp; and
determining whether control of the second metric is being adversely affected by control of the first metric by the first xApp.

11. The system of claim 10, wherein the operations further comprise:
in response to determining that the control of the second metric by the second xApp is being adversely affected by control of the first metric by the first xApp, terminating operation of the first xApp.

12. The system of claim 10, wherein the operations further comprise:
in response to determining that the control of the second metric by the second xApp is being adversely affected by the control of the first metric by the first xApp, operating the first xApp for a first period of time; and
operating the second xApp for a second period of time, wherein the first period of time and the second period of time are non-overlapping and disparate.

13. The system of claim 10, wherein the operations further comprise:
in response to determining that the control of the second metric by the second xApp is not being adversely affected by the control of the first metric by the first xApp, determining operation of a third metric at the RAN;
determining whether the operation of the third metric at the RAN is being adversely affected by a combination of the first metric being controlled by the first xApp and the second metric being controlled by the second xApp; and
in response to determining that operation of the third metric at the RAN is being adversely affected by the combination of the first metric being controlled by the first xApp and the second metric being controlled by the second xApp, terminating operation of the first xApp.

14. The system of claim 10, wherein the first metric has a key performance indicator (KPI) configured to identify operation of the first metric, and wherein the first metric relates to at least one of coverage of the RAN, capacity of the RAN, or an energy-related performance of the RAN.

15. The system of claim 10, wherein the system is one of a real-time RAN intelligent controller (RIC), a near-real-time RIC, or a non-real-time RIC.

16. A computer program product stored on a non-transitory computer-readable medium and comprising machine-executable instructions, wherein, in response to being executed, the machine-executable instructions cause a machine to perform operations, comprising:
identifying a first operational characteristic of a first application (xApp);
identifying a second operational characteristic of a second xApp, wherein the first xApp and second xApp are configured to be executed via a radio access network (RAN); and
determining whether the first operational characteristic of the first xApp is threshold likely to negatively affect the second operational characteristic of the second xApp in the event of the first xApp being co-deployed on the RAN with the second xApp.

17. The computer program product according to claim 16, wherein the operations further comprise:
responsive to a determination that the first operational characteristic of the first xApp is threshold likely to negatively affect the second operational characteristic of the second xApp in the event of the first xApp being co-deployed on the RAN with the second xApp:
denying onboarding of the first xApp on the RAN.

18. The computer program product according to claim 16, wherein the operations further comprise:
responsive to a determination that the first operational characteristic of the first xApp is a not threshold likely to negatively affect the second operational characteristic of the second xApp in the event of the first xApp being co-deployed on the RAN with the second xApp:
co-deploying, on the RAN, the first xApp with the second xApp, resulting in a co-deployment of the first xApp and the second xApp.

19. The computer program product according to claim 18, wherein the operations further comprise:
monitoring operation of a metric at the RAN;
determining whether the operation of the metric at the RAN is being adversely affected by the co-deployment of the first xApp and the second xApp; and
responsive to the metric being determined to be adversely affected by the co-deployment of the first xApp and the second xApp, terminating operation of the first xApp.

20. The computer program product according to claim 15, wherein the machine is one of a real-time RAN intelligent controller (RIC), a near-real-time RIC, or a non-real-time RIC.
